(19) United States
(12) Patent Application Publication
(10) Pub. No.: US 2011/0234598 A1
(43) Pub. Date: Sep. 29, 2011

(54) SYSTEM AND METHOD TO MANAGE HAND HYGIENE

(75) Inventors: Todd Scarola, Glenn Allen, VA (US); Chuck Hall, Tallahassee, FL (US)

(73) Assignees: GENERAL ELECTRIC COMPANY, Schenectady, NY (US); C/HCA, INC., Nashville, TN (US)

(21) Appl. No.: 12/731,263

(22) Filed: Mar. 25, 2010

(51) Int. Cl. G09G 5/22; H04Q 5/22; G08B 21/00

(52) U.S. Cl. 345/440.1; 340/10.1; 340/540

(57) ABSTRACT

A system and method to track management of hand hygiene is provided. The system includes a wireless tracking system to detect a resource within a proximity of a dispenser of sanitizer. The system can detects a release of the sanitizer from the dispenser, transmits a wireless signal from a transmitter at the dispenser to a receiver, and creates a display that includes a time of the release of sanitizer at the dispenser and a resource within the proximity of the dispenser at the time of release.

### BACKGROUND OF THE INVENTION

This invention generally relates to a system for and method to manage hand hygiene.

Infections can result in operation of hospitals or clinics or other healthcare environments in association with interaction of the healthcare provider with multiple patients, deliverables, or surfaces over a time interval or at the surgical point of care. Not only can infections be harmful to the health of the patient, but also increase costs to treat the patient and can harm a reputation of a healthcare institution.

### BRIEF DESCRIPTION OF THE INVENTION

The subject matter described herein provides a system and method to track and reduce the occurrence of failure follow proper hand hygiene procedure, which can reduce a probability of infection rates associated with improper hand hygiene. The subject matter of the system and method described herein also enhances visualization of the protocol in delivery of healthcare to the patient without unduly interrupting or interfering with the performance of the staff in delivering healthcare to a patient.

The above-mentioned shortcomings, disadvantages and problems are addressed by the embodiments described herein in the following description.

One embodiment of the subject matter described herein includes a method to manage hand hygiene, the method comprising the steps of: detecting a release of sanitizer from a dispenser; transmitting a wireless signal from a transmitter at the dispenser to a receiver; and creating a graphic illustration of a time of the release of sanitizer at the dispenser.

Another embodiment of the subject matter described herein includes a system to track a resource use of a dispenser of sanitizer, the dispenser having a handle to release the sanitizer, the system comprising: a wireless transmitter located at the dispenser, the wireless transmitter to transmit a wireless signal including a location address of the dispenser and a time of release of sanitizer from the dispenser; a magnet at the handle of the dispenser that moves with the handle to trigger transmitting of the wireless signal from the wireless transmitter at the dispenser; a tracking system to communicate a wireless signal including an identifier of the resource and a time of detection of the resource within a predetermined proximity of the dispenser; and a display of an identification of the resource at the time of the release of sanitizer from the dispenser.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows a schematic block diagram of an embodiment of a system to manage hand hygiene.

FIG. 2 shows a flow diagram of an embodiment of a method to manage hand hygiene.

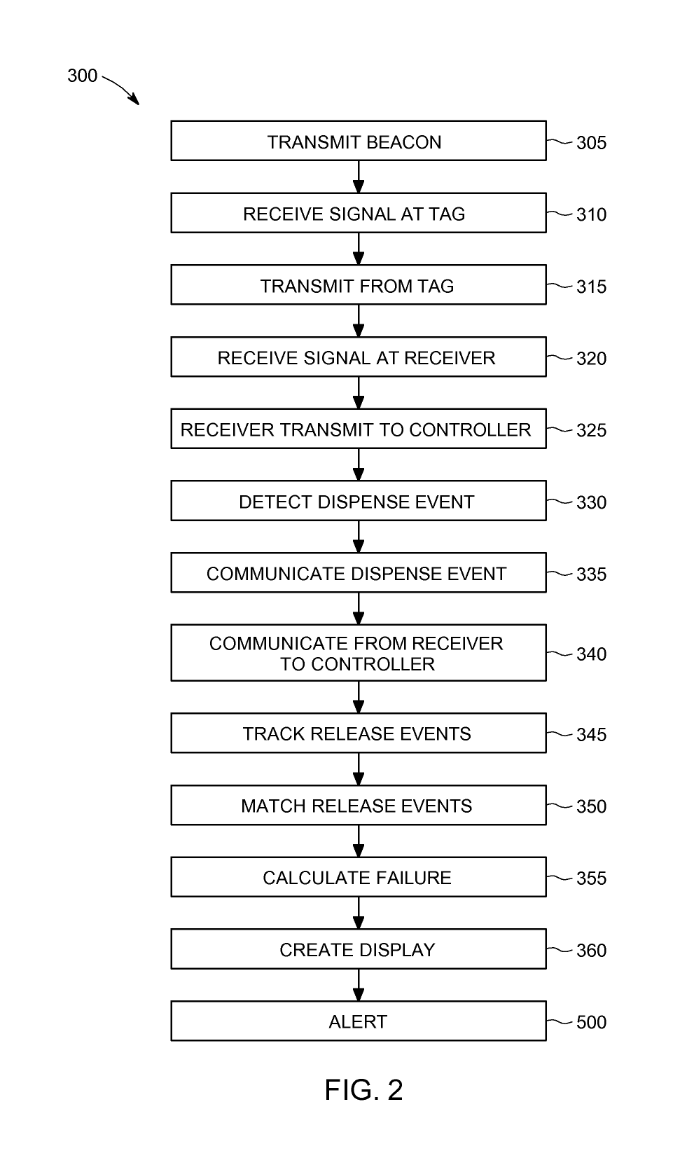

FIG. 3 shows a schematic diagram of an embodiment of a display to illustrate management of hand hygiene by the system of FIG. 1.

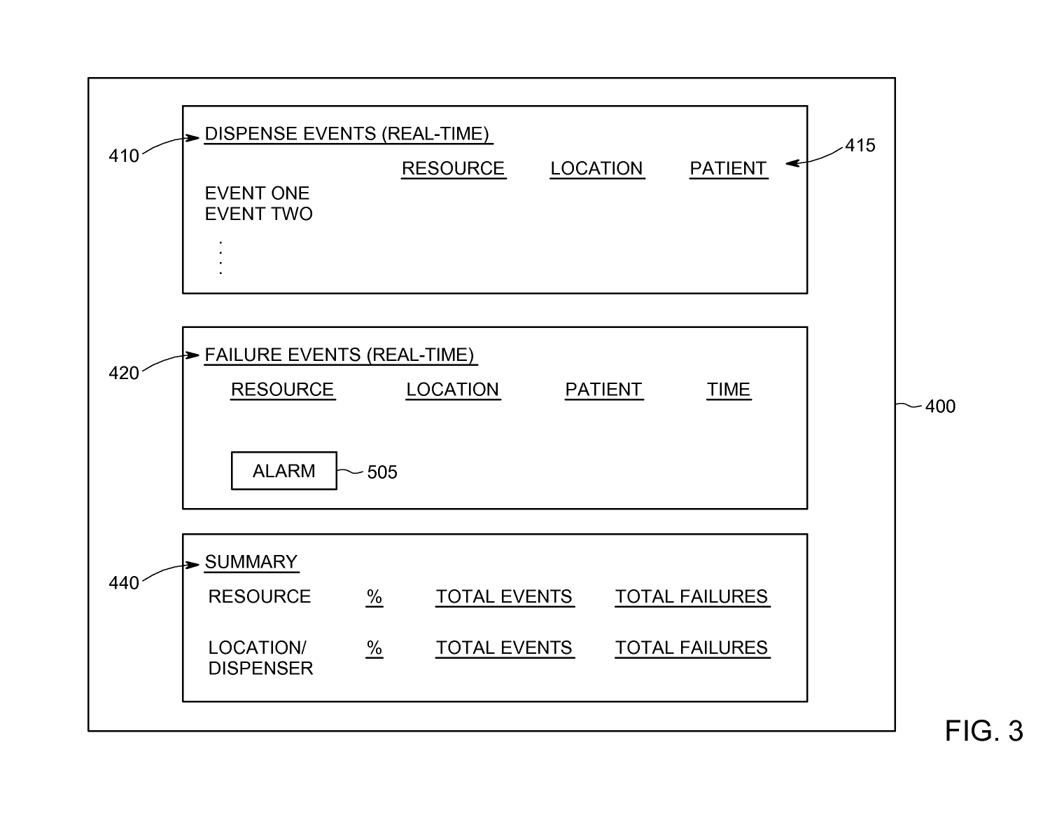

FIG. 4 shows a schematic diagram of another embodiment of a display to illustrate management of hand hygiene.

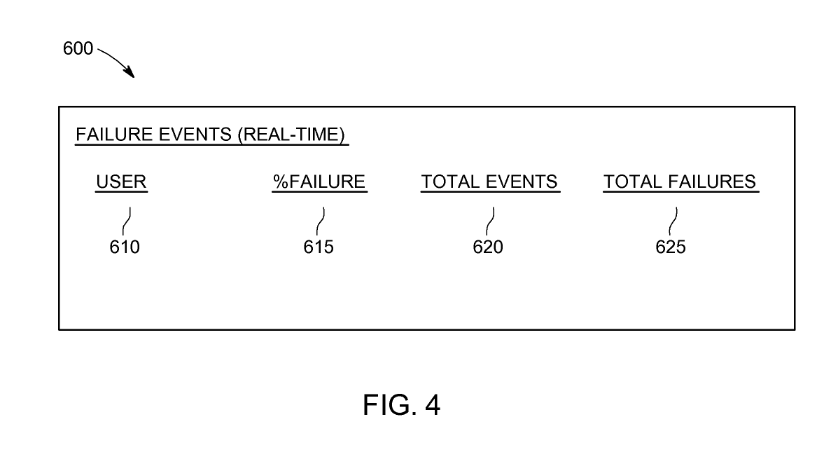

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The following description subject matter is an example that is generally described with reference to a healthcare environment. It can be appreciated that managed activity may occur in many venues (e.g., home, food service, ambulatory or healthcare settings) and is not limiting on the subject matter described herein.

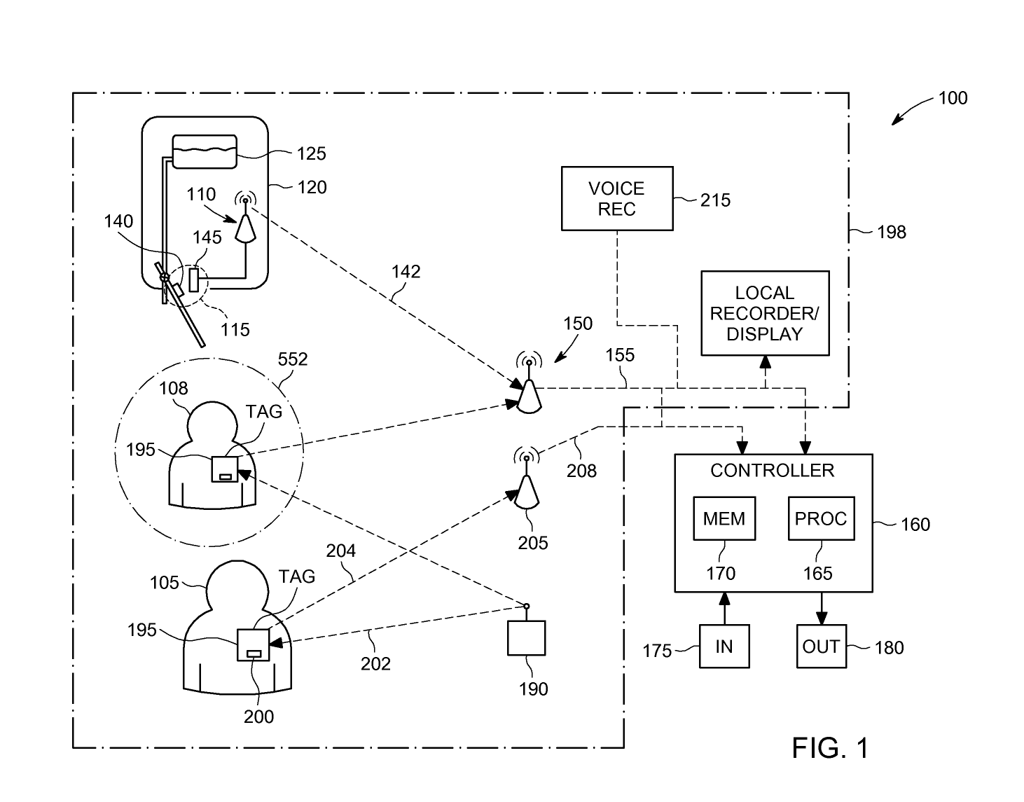

FIG. 1 illustrates an embodiment of a system 100 to manage hand hygiene. One embodiment of the system 100 can be directed to manage hand hygiene of a resource 105 in regard to delivery of healthcare (e.g., diagnosis or treatment) to a patient 108. One embodiment of the system 100 can generally include a transmitter 110 and sensor 115 in combination with a dispenser 120 of a dose of sanitizer (e.g., antiseptic, soap, detergent, cleaning agent, etc.) 125.

The embodiment of the dispenser 120 can generally include an actuator lever or lever arm 130 that when pulled, pressed or otherwise moved causes the release or dispense of a dose of sanitizer 125 (e.g., such as cleaning of hands before examination or treatment of a patient 108). In one example, the resource 105 can be a caregiver that applies a force to move the actuator lever 130 to trigger the release of the dose of sanitizer 125. Yet, type of actuator lever 130 to trigger release of the sanitizer 125, the type of sanitizer 125, and the measure of dose can vary. The dispenser 120 can be motorized or operate manually to pump or release the dose of sanitizer 125.

For example, the dispenser 120 can release a dose of sanitizer 125 in a sufficient amount (e.g., multiple shots of predetermined amount (or unit dose size)) upon pressing the lever 130 of the dispenser 120 (e.g., dispense one shot per compression of the actuator lever 130). The dispenser 120 can be refillable and stationary, or issued from and returned to a control station that refills each dispenser 120. Another example of the supply of sanitizer 125 in the dispenser 120 can be provided in replaceable, throwaway, sanitizing agent-containing cartridges of single or multiple storage compartments.

An embodiment of the sensor 115 can be operable to regulate activation or transmission of a wired or wireless signal from the transmitter 110. One embodiment of the sensor 115 includes a magnet 140 in combination with a magnetic switch 142. The magnetic switch 142 can be located or attached at the actuator lever 130. The magnet 140 can be located adjacent to or at some proximal distance to the actuator lever 130. The magnetic switch 142 and the magnet 140 can be located proximal to one another such that the magnetic switch 142 can be triggered or activated when the actuator lever 130 moves the magnetic switch 142 within a certain predetermined distance of or makes contacts with the magnet 140. In an alternative embodiment, the magnet 140 can be of such polarity and located at or attached to the actuator lever 130 so as to trigger or activate or close the magnetic switch 142 when the magnet 140 moves with the actuator lever 130 within a certain predetermined distance of or makes contact with the magnetic switch 142. In yet another alternative embodiment, the magnet 140 can be of such polarity so as to deactivate or open the magnetic switch 142 when within a predetermined distance of or makes contact with one another so as to cause transmission or communication from the transmitters 110, or interruption of transmission or communication thereof.

One embodiment of the magnetic switch 142 can be connected to regulate electrical power to the transmitter 110. According to one embodiment, the magnetic switch 142 can be connected such that in a rest or normal disposition can interrupt electrical power to the transmitter 110, and when activated or energized by the magnet 140 can communicate electrical power to the transmitter 110. In another embodiment, the magnetic switch 142 can be connected such in a rest position communicates electrical power to the transmitter 110, and when activated or energized by the magnetic switch 142 can interrupt communication electrical power to the transmitter 110.

Another embodiment of the sensor 115 can be a motion detector or accelerometer operable to regulate the transmission from the dispenser transmitter 110 in response to detecting release of sanitizer 125 from the dispenser 120. The motion detector or accelerator 115 can be located and configured to detect movement of the actuator lever 130 (e.g., either at the lever 130 or at a location independent thereof). Alternatively, the sensor 115 can be a flow detector or other type of mechanical switch or electrical switch operable to regulate transmission from dispenser transmitter 110 in response to actuation of the actuator lever 130 or release of the sanitizer 125 from the dispenser 120. Yet another embodiment of the sensor 115 can be an infrared reflective proximity sensor operable to detect an obstruction (e.g., physician or other healthcare personnel). The infrared reflective proximity sensor can include one or more LEDs operable to generate an IR beam that when unobstructed does not activate or cause transmission from the transmitter 110. When the IR beam from the LED may be obstructed or interrupted, the reflection of the IR beam onto a phototransistor or other optical sensor can trigger or cause transmission from the transmitter 110.

An embodiment of the transmitter 110 can be operable to transmit a signal 145 to a receiver 150. An embodiment of the transmitter 110 and receiver 150 can in wireless communication to transmit and receive a radio frequency (RF) signals. Yet, the type of communication (e.g., wireless, infrared, optical, wired communication of electrical signal, etc.) between the transmitter 110 and receiver 150 can vary.

The receiver 150 can be connected to communicate (e.g., via a local area network, broadband connected, etc.) a signal (including the received signal or representation or translation thereof) 155 to a controller 160. An embodiment of the signal 155 communicated from the receiver 150 can include a unique identification (ID) of the transmitter 110 and/or the receiver 150 associated with the dispenser 120 or location of the dispenser 120 or an ID representative of a class or category of dispenser 120 or class or category of an area that the dispenser 120 is located. The ID can be incorporated from the received signal 145 transmitted from the transmitter 110 or can be incorporated from memory storage at the receiver 150.

The communication of the signal 155 to the controller 160 can be via a wireless connection (e.g., radio frequency, etc.) or wired connection (e.g., communication bus, etc.) or combination thereof. Communication can be direct, or over an Internet network or an Ethernet network or a local area network (LAN).

The controller 160 can include one or more processors 165 in communication with a memory 170. An embodiment of the memory 170 can include one or more or combination thereof of the following: hard drive, cd, dvd, magnetic storage medium, remote database, tape, flash memory, etc. or other medium operable to store programmable instructions or data for retrieval or execution by the processor 165.

An embodiment of the controller 160 can include a computer in a desktop configuration or laptop configuration or central workstation or kiosk or server or remote workstation. Yet, the type of controller 160 can vary. An embodiment of the memory can include a computer-readable storage medium (e.g., compact disc (CD or magnetic storage medium), DVD, memory stick, random access memory (RAM), random operating memory (ROM), etc.) generally operable to receive and record a plurality of programmable instructions for execution by the processor 165.

The controller 160 can be connected in communication with an input device 175 and an output device 180. An embodiment of the input device 175 can be a keyboard, mouse, touch-screen, toggle switch, or combination thereof. An embodiment of the output device 180 can be a monitor or other graphic display screen, touch-screen, LEDs, audible alert, or combination thereof.

An embodiment of the system 100 can further include a stationary wireless transmitter 190 in combination with one or more wireless tags 195. An embodiment of the wireless transmitter 190 can include a unique or categorized identification or location address of a predefined area 198. An embodiment of the wireless tag 195 can be an RF tag including a transceiver 200 (combination transmitter and receiver) and a unique identification address. The stationary transmitter 190 can be configured to communicate a signal (e.g., electromagnetic, infrared, optical, voice recognition, etc.) 202 including a location address to the wireless tag 195. An embodiment of the wireless tag 195 can be worn by the resource (e.g., caregiver, nurse, physician, wheelchair, gurney, etc.) 105. The wireless tag 195 can be configured to receive the signal from the stationary transmitter or beacon 190, and in response can generate a signal 204 (e.g., electromagnetic, infrared, optical, voice recognition, etc.) combining the location address of the stationary transmitter 190 with an identification address of the wireless tag 195 for transmission or communication to a receiver 205. The receiver 205 can be operable transmit a wireless (e.g., electromagnetic, infrared, optical, voice recognition, etc.) or wired signal 208 including the location address of the stationary transmitter 190 with the identification address of the wireless tag 195 for communication to the controller 160. An embodiment of the receiver 205 can be common to or in combination with the receiver 150 described above or independent thereof.

The system 100 can include a voice recognition system 215 operable to detect an occurrence of a caregiver (e.g., individual or category of physician, nurse, practitioner, assistant, etc.) at the location of or in interaction with the patient (e.g., based on proximal distance with respect to one another) 108. An embodiment of the voice recognition 215 system can be operable to record speech of the resource and to perform voice recognition so as to translate speech to alphanumeric language in a digital or analog context for communication to the controller. The voice recognition system 215 can further be operable to parse the alphanumeric language for key words or phrases or fragments thereof for communication to the controller for comparison to templates that include keywords, phrases, or fragments thereof representative of protocol or steps of the medical procedure being performed on the patient.

The system 100 may utilize a combination of optics, shape recognition, voice recognition, motion detection, and wireless tracking technologies and can request confirmation feedback on the system's reasoning as to what is being observed by the system 100.

Having provided the above description of the construction of the system 100, the following is a description of an embodiment of a method 300 of managing hand hygiene. It should be understood that the sequence of the acts or steps of the method 300 as discussed in the foregoing description can vary. Also, it should be understood that the method 300 may not require each act or step in the foregoing description, or may include additional acts or steps not disclosed herein. It should also be understood that one or more of the steps of the method 300 can be represented as modules of computer-readable program instructions in the memory 150 for execution by one or more processors of the controller 125 or remote computer terminal.

Assume for sake of example that the system 100 is installed at a healthcare clinic or hospital, and that mobile resources (e.g., caregivers, wheelchairs, etc.) are provided with wireless tags for communication with stationary wireless transmitters and receivers in selected areas or rooms of the hospital.

Step 305 includes transmitting the wireless or beacon signal 202 from the stationary transmitter 190 at a predefined location. The wireless signal 202 can include a location address of the area 198 of the transmitter 190 or an identification address that can translate to the location address at the controller 160. One embodiment of the signal 202 can be an infrared (IR) signal, but the type of signal 202 can vary.

Step 310 includes receiving the wireless signal 202 at the wireless tag 195 located at one of the resources 105 or patients 108. Each tag 195 can include a unique identification address in memory storage. The unique identification address can be associated with each individual resource 105 or a classification or category of resources 105 or each individual patient 108 or category of patients 108.

Step 315 can include transmitting the second wireless signal 204 including the location address of the transmitter 190 in combination with an identification address of the tag 195. Step 320 can include receiving the second wireless signal 204 at the receiver 150, 205.

Step 325 can include transmitting a third signal 155, 208 from the receiver 150, 205 to the controller 160. The signal 155, 208 can include the transmitter location address, the tag identification address, and a time stamp or combination thereof. The time stamp can be associated with time of reception of the first signal 202 at the tag 195, the time of transmission of the signal 204 from the tag 195, the time of reception of the signal 204 at the receiver 150, 205, or the time of transmission of the signal 155, 208 from the receiver 150, 205 to the controller 160. Alternatively, the time stamp can be associated with the time of reception of the third signal 155, 208 at the controller 160.

Step 330 can include detecting event of sanitizer. One embodiment of step 330 can include detecting movement of the actuator lever 130 at the sanitizer dispenser 120. As described above, the step 330 of detecting movement of the lever 130 can be performed by the sensor (e.g., magnetic switch, motion detector, mechanical switch, electrical switch, etc.) 115 located at or adjacent to the actuator lever 130 of the dispenser 110.

Step 335 can include communicating the dispense event to the controller 160. One embodiment of step 335 can include triggering transmission or communication of the dispenser signal 145 from the transmitter 110 at the dispenser 120 in response to the step 330. The communication of the signal 145 can be a wireless (e.g., RF, infrared, optical, etc.) or wired communication. An embodiment of the dispenser signal 145 can include the identification address of the dispenser 120 or location thereof. Alternatively, the identification of the dispenser 120 can be associated with an identification of the receiver 150 or location thereof. In another alternative, the identification of the dispenser 120 can be generated at the controller 160 based on stored data of addresses matched or correlated unique individual, classification, or category of dispensers 120 or locations thereof.

Step 340 can include communicating the signal 155 from the receiver 150 to the controller 160. An embodiment of the signal 155 can include an identification of the dispenser 120 or location thereof which transmitted the dispenser signal 145. Alternatively, step 340 can include transmitting the signal 155 from the receiver 150 that includes an identification address of the dispenser 120 in combination with an identification of the wireless tag 195 of the patient 108 or resource 105 within a predetermined proximity or area 198 of the dispenser 120.

Step 345 can include tracking or counting a number of sanitizer dispense or release events overall, or the number of dispense events associated with each individual, classification, or category of dispenser 120 or location thereof. An embodiment of step 345 can include correlating each or time period of dispense events with individual, classification, or category of resource 105. An embodiment of step 345 can include matching or correlating the signal 208 communicated from the receiver 150, 205 in step 340 with the signal 155 communicated from the receiver 150 associated with step 325. The time stamp of the signal 155 in step 325 can be correlated to the time stamp of the signal 155, 208 in step 340 to determine a match or correlation of the individual, classification, or category of resource 105 in the area or room 198 at the time or threshold time frame of the dispense or release event.

Step 350 can include correlating or matching the number of dispense or release events overall, or the number of dispense or release events associated with each individual, classification, or category of dispenser 120 or location thereof 198 with detection of individual or category of patients 108 at the area or location 198. An embodiment of detection of an occurrence or completion of treatment or delivery of care or diagnosis to the patient 108 can include tracking and comparing the location of at least one of the plurality of resources 105 relative to a control volume 352 associated with the patient 108.

Step 355 can include calculating a failure of occurrence or detection thereof of the dispense release event at the dispenser 120 associated with detection of a presence or delivery of care or treatment to the patient 108 at the location or area 198 of the dispenser 120 or category thereof. The step 355 can include counting a number or individual occurrence of unmatched or uncorrelated patients 108 or indications of care or treatment thereto relative to occurrence or detection thereof of release events at the individual, category, or classification of dispensers 120 or location thereof 198. The step 355 can performed overall for the number of dispense release events at the hospital, or with respect to the specific locations 198 or addresses of the dispensers 120, or with respect to categories or classification of patients 108 or dispensers 120 or locations 198 thereof.

Step 360 can include creating a display 400 illustrative of the data generated by the system 100. An embodiment of the display 400 can include a graphic illustration of a number of dispense or release events overall, or the number of dispense or release events associated with each individual, classification, or category of dispenser 120 or location thereof 198 as calculated in step 345; a graphic illustration 415 of each or time period of dispense events with individual, classification, or category of resource 105 or patient 108 as calculated in step 350; and a graphic illustration 420 of each individual occurrence or overall count of failures of dispense events as recited in step 355 associated with unmatched or uncorrelated patients 108 or indications of care or treatment thereto with respect to occurrence or detection thereof of release events at the individual, category, or classification of dispensers 120 or location thereof 198 or with respect to individual, category, or classification of resource 105 or combination thereof; and a graphic illustration 425 that shows the location of the failure of the occurrence or detection thereof on a dashboard or map of the areas of the hospital where the system 100 is performing management of hand hygiene.

The display 400 can further include graphic illustration 440 of a summary of the release events and failures per resource 105 and location 198 or dispenser 120, including a percentage success rate or failure rate, a total number of successful dispense or release events, and a total number of failures.

Step 500 can include generating an alarm (e.g., visual and or audible) 505 at the display 400 or at the location of the failure in response to calculating the failure of occurrence or detection thereof of the release event at the dispenser 120 associated with detection of a presence or delivery of care or treatment to the patient 108 at the location or area of the dispenser 120 or category thereof as described in step 355.

An embodiment of the graphic illustrations 415, 420, 425, 440 of display 400 can be shown on one screen or multiple screens (e.g., windows) via graphic links or icons.

The system 100 can also be connected in communication with miscellaneous other resources 105, including health information systems (HIS). The type (e.g., electromagnetic, optical, rF/IR, accelerometers, voice recognition, global positioning, etc. or combination thereof) of location tracking technologies and combinations thereof to locate positions or movement of resources 105 or moveable components thereon or patients can vary.

Although the system 100 and method 300 are described with reference to a healthcare environment, the subject matter of the system 100 and method 300 are not so limited. For example, the system 100 and method 300 can be applied to any commercial or industrial setting (e.g., food service, food processing, pharmaceutical manufacturing, etc.) where hand hygiene management is a concern. For example, the system 100 and method 300 can include creating a display 600 that includes graphic illustrations of a unique employee identification or classification or category 610 correlated to a calculated percentage 615 failure of occurrence of release of sanitizer to the user, a total number 620 of hand hygiene events by the user, and a total number 625 of failure of occurrence of release of sanitizer by the user.

One or more elements or constructions of one or more embodiments of the subject matter described above may be combined with one or more elements or constructions of other embodiments of the subject matter described above and is not limiting on the subject matter described herein.

A technical effect of the subject matter described herein can include to provide a low cost system 100 and method 300 to remotely monitor or track a dispense event of sanitizer directed to manage hand hygiene and compliance, including calculating patterns of usage.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A method to manage hand hygiene, the method comprising the steps of
detecting a release of sanitizer from a dispenser;
transmitting a wireless signal from a transmitter at the dispenser to a receiver; and
creating a graphic illustration of a time of the release of sanitizer at the dispenser.

2. The method of claim 1, further comprising the steps of:
tracking a location of a resource within a predetermined proximity of the dispenser;
communicating a wireless signal including a location address and an identifier of the resource at a time of tracking;
matching the location of the resource with a control volume of the dispenser at the time of the release of sanitizer; and
generating a graphic illustration that shows an identification of the resource within the control volume of the dispenser at the time of the release of sanitizer.

3. The method of claim 1, further comprising the steps of:
tracking a location of a resource within a predetermined proximity of the dispenser;
communicating a wireless signal including a location address and an identifier of the resource at a time of tracking;
matching the location of the resource with the dispenser at the time of the release of sanitizer; and
detecting a failure of an occurrence of a release of sanitizer from the dispenser prior to a predefined event.

4. The method of claim 3, wherein the step of tracking includes communicating an infrared signal having an identifier of a stationary beacon to a tag at the resource, and wherein the step of communicating includes communicating an rF signal from a tag that includes the identifier of the stationary beacon and an identifier of the resource having the tag.

5. The method of claim 4, wherein the transmitting step includes communicating an rF signal from a tag at the dispenser.

6. The method of claim 3, wherein the predefined event is the delivery of healthcare to a patient, and further comprising the step of:
tracking the location of the resource within a control volume of a patient, wherein the failure occurs if a time of release of sanitizer is after a time tracking the resource within the control volume of the patient.

7. The method of claim 6, further comprising the step of creating a display illustrative of each failure of occurrence of the release of sanitizer associated with delivery of healthcare to the patient, and the resource associated with delivery of healthcare to the patient.

8. The method of claim 6, further comprising the step of creating a display illustrative of a percentage rate of failure of occurrence of the release of sanitizer overall for more than resource.

9. The method of claim 6, further comprising the step of creating a display illustrative of a percentage rate of failure of occurrence of the release of sanitizer for each unique individual or category of resource.

10. The method of claim 6, further comprising the step of creating a display illustrative of a percentage rate of failure of occurrence of the release of sanitizer for each unique individual dispenser of sanitizer or category of dispenser of sanitizer.

11. The method of claim 6, further comprising the step of creating a display that shows a graphic illustration of the location of the failure of the occurrence on a map of a facility.

12. The method of claim 6, further comprising the step of creating an alarm illustrative to the patient of the failure of the occurrence of the release of sanitizer.

13. The method of claim 1, wherein the step of detecting the release of sanitizer includes applying a magnet at a handle of the dispenser that within one of a detection of a predefined distance and detection of contact causes a switch to move and trigger transmitting of the wireless signal from the transmitter.

14. The method of claim 1, wherein the step of detecting the release of sanitizer includes detecting a motion of a handle of the dispenser to cause release of the sanitizer; and in response to detecting the motion of the handle, triggering the step of transmitting of the wireless signal from the transmitter.

15. The method of claim 1, wherein the step of detecting the release of sanitizer includes triggering the step transmitting of the wireless signal from the transmitter in response to actuation of a mechanical or electrical switch caused by a motion of a handle of the dispenser to cause release of the sanitizer or detection of a flow of sanitizer from the dispenser.

16. The method of claim 1, further comprising the step of communicating a signal including data indicative of at least one of the failure of occurrence of release of sanitizer and a detection of occurrence of the release of sanitizer for storage in an electronic medical record (EMR) of the patient.

17. The method of claim 1, wherein the wireless signal from the transmitter includes one of an infrared, radio frequency (rF), electromagnetic, and an optical signal transmission.

18. The method of claim 1, further comprising the steps of:
tracking a location of a resource within a predetermined proximity of the dispenser;
communicating a wireless signal including a location address and an identifier of the resource at a time of tracking;
matching the location of the resource with the dispenser at the time of the release of sanitizer; and
detecting a failure of an occurrence of a release of sanitizer from the dispenser prior to a predefined event, wherein the resource is a food handling personnel and the predefined event is the personnel performing a food handling service.

19. A system to track a resource use of a dispenser of sanitizer, the dispenser having a handle to release the sanitizer, the system comprising:
a wireless transmitter located at the dispenser, the wireless transmitter to transmit a wireless signal including a location address of the dispenser and a time of release of sanitizer from the dispenser;
a magnet at the handle of the dispenser that moves with the handle to trigger transmitting of the wireless signal from the wireless transmitter at the dispenser;
a tracking system to communicate a wireless signal including an identifier of the resource and a time of detection of the resource within a predetermined proximity of the dispenser; and
a display of an identification of the resource at the time of the release of sanitizer from the dispenser.

20. The system of claim 19, wherein the wireless tracking system detects a location of the resource at the time of release of the sanitizer from the dispenser, and wherein the system detects a failure of the release of sanitizer from the dispenser prior to a predefined event of the resource and creates a display illustrative of the failure.
